(19) United States
(12) Patent Application Publication
(10) Pub. No.: US 2005/0136834 A1
(43) Pub. Date: Jun. 23, 2005

(54) Communication system with adopted remote identity

(75) Inventors: Jeffrey D. Bonta, Arlington Hts, IL (US); George Calcev, Hoffman Estates, IL (US)

Correspondence Address: POSZ LAW GROUP, PLC, 12040 SOUTH LAKES DRIVE, SUITE 101, RESTON, VA, 20191, US

(73) Assignee: MOTOROLA, INC.

(21) Appl. No.: 10/742,017

(22) Filed: Dec. 19, 2003

(51) Int. Cl. H04B 7/15; H04B 7/00

(52) U.S. Cl. 455/11.1; 455/41.2

(57) ABSTRACT

A method (700), and apparatus (100-600) provide for the establishment of a wireless network connection between a remote unit (110) and a wireless network (130) through a communication unit (120) acting as a relay. In one embodiment an ad-hoc connection (101) is established between the remote unit (110) and the communication unit (120). An identifier (119) associated with the remote unit (110) is adopted by the communication unit (120) for the purpose of authenticating the establishment of a wireless network connection (102) with the wireless network (130), such that a session may be established between the remote unit (110) and the wireless network (130).

### FIELD OF THE INVENTION

The present invention relates in general to wireless communication systems, such as mobile receivers, transceivers, base units, and related equipment, and more specifically to the adoption of remote identities from an ad hoc connection with such devices.

### BACKGROUND OF THE INVENTION

Service pricing plans for cellular systems have become increasingly competitive with pricing for wireline service. As a result, cellular communications may soon replace wireline service in the home and small business for providing service for routine day-to-day communication needs. Drawbacks still remain inhibiting the widespread use of wireless communications at a level sufficient to eclipse wireline use. New paradigms associated with day-to-day wireless usage in contexts presently centered around standard wireline phones, both in the home and in the office or enterprise, are necessary to remove barriers limiting the acceptance of wireless replacements.

At the same time, creating a new demand for wireless devices with features sufficiently attractive to encourage wireline replacement is equal in importance to removing the above identified barriers. As equipment providers throughout the cellular industry have continued to shrink the size of the typical handset and provided enhanced aesthetic features such as colorful covers and unique physical designs in an effort to attract more users, there appears to be increasingly fewer areas for continued development in handset size and appearance.

Despite advances in size and appearance, problems exist in other areas. For example, the very act of placing or answering a call with a typical wireless device regardless of its size or appearance remains clumsy and antiquated whether operating in a home or office environment. Further, most cellular handset users prefer one handed operation, both in view of the small size of typical handsets, and in view of the fact that, by definition, cellular handset use is closely linked with mobility and attendant activity making one-handed use preferable as a way of keeping the other hand free for other activities. It is well understood however that one handed use often leads to problems including misdialing the phone, dropping the phone, or the like. It would be desirable to provide a solution that reduces or eliminates the inevitable fumbling associated with operating the typical cellular handset, e.g. for opening the phone and finding the correct buttons to push—all preferably with one hand. While some systems, such as hands-free phones with voice activated dialing have been helpful, a more revolutionary approach to communication should improve usability and re-energize focus on wireless technology.

Other barriers exist to increasing ubiquitous-ness of cellular handsets including the inconvenient fact that the typical handset must always be carried on a belt, in a purse or pocket, or the like in order to have ready access to answer an incoming call or to place an outgoing call. Often times, calls received on handsets buried, for example, in a pocket or purse are missed since the user must first hear or feel the ring indicator, and then locate the handset. When considering the drawbacks associated with wireline phone alternatives, wireless handsets are still preferred but are not ideal in certain settings such as an office setting.

In a typical office environment, where a user is stationed, for example, at a desk, workstation or the like, the typical wireline desk phone can be more convenient than a wireless handset, particularly for lengthy business calls and particularly in view of features such as hands free or intercom features. However, since the typical desk phone is stationary, desk phone users are required to be at or near their desk, for example, when an important call is expected. Some wireless office solutions exist however, the attendant need to clip on a handset while walking within the office is not only uncomfortable and inconvenient but does not always reflect a polished appearance. In any environment whether home or office, where comfort is at a premium, a traditional cellular handset may be burdensome.

Still other barriers to the ubiquitous-ness of wireless handset use within the home or office exist, including, for example, gaps in coverage in the indoor environment. While the overwhelming evidence suggests that it is not unrealistic to expect a typical user to become accustomed to carrying a wireless handset around, there are often areas, particularly indoors within the home or office, having poor cellular coverage or no coverage at all. It will be appreciated that some additional range can be achieved through the use of various techniques but most require that the handset be carried with the user.

Accordingly, it would be desirable in the art for a solution to the problems associated with using a wireless handset.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages in accordance with the present invention.

FIG. 1 is a diagram depicting an environment with exemplary remote units, exemplary communication units, an exemplary wireless network, and exemplary connections there between;

FIG. 2 is a diagram depicting components of an exemplary remote unit;

FIG. 3 is a diagram depicting components of an exemplary communication unit;

FIG. 4 is a diagram further depicting additional components associated with the exemplary remote unit of FIG. 2;

FIG. 5 is a diagram further depicting additional components associated with the exemplary communication unit of FIG. 3;

FIG. 6 is a diagram depicting a connection scenario between a remote unit and a communication unit showing an exemplary adoption of an identifier;

FIG. 7 is a flow chart illustrating various procedures associated with an exemplary method for providing a connection to a wireless network; and

FIG. 8 is a diagram illustrating an exemplary connection scenario associated with a remote unit, one or more communication units, and a wireless network in an indoor communication environment.

### DETAILED DESCRIPTION OF PREFERRED EMBODIMENTS

In overview, the present disclosure concerns the establishment of an ad-hoc network connection or communication channel between a remote unit and a communication unit such as, for example, a relay unit, and the establishment of a wireless network connection associated with a wireless network, Radio Access Network (RAN), or the like, and a wireless interface to the relay unit, which is preferably a device such as a stationary or fixed mobile receiver, communications unit, and the like and a method and apparatus for establishing a connection between the remote unit and the wireless network through the ad-hoc network connection, the relay unit, and the wireless network connection by adopting the identifier associated with the remote unit in the relay unit and making the wireless network connection with the adopted identity.

It should be noted that conventional methods typically require the remote unit, or any unit attempting to gain access to the wireless network, to have an identity, such as a Network Access Identifier (NAI), Electronic Serial Number (ESN), Mobile Identification Number (MIN), Mobile IP (MIP) address, or the like, or a combination of identities, associated therewith. In accordance with various exemplary embodiments, the present invention allows a relay unit to adopt the identity of the remote unit through the ad-hoc connection such that a fully authenticated wireless network connection between the remote unit and the wireless network through the relay unit and the ad-hoc connection, can be established without the remote unit having to be equipped with a complete wireless network interface. Rather the remote unit is preferably equipped with an ad-hoc network interface. A capability to generate voice signals is preferably incorporated into the remote unit to allow the transfer of voice signals associated with a conversation, a voice command, or the like, by further equipping the remote unit with a voice unit.

It will be appreciated that various functions associated with establishing ad-hoc network connections, wireless network connections, and the like may be performed in the communication unit or relay unit, and the remote unit having, for example, a dedicated processor, a processor coupled to an analog voice unit or circuit or analog/digital voice unit, voice recognition unit or the like, with appropriate software for performing voice related functions and network control functions, an application specific integrated circuit (ASIC), a digital signal processor (DSP), or the like, or various combinations thereof, as would be appreciated by one of ordinary skill. Memory devices may further be provisioned with routines and algorithms for operating on input data and providing output such as voice data, control data, network commands, and the like, and otherwise appropriately handling the input data.

It will further be appreciated that the term communications unit may refer to a subscriber device such as a cellular or mobile phone, a two-way radio, a messaging device, a personal digital assistant, a personal assignment pad, a personal computer equipped for wireless operation, a cellular handset or device, or the like, or equivalents thereof provided such units are arranged and constructed for operation in accordance with the various inventive concepts and principles embodied in exemplary communication units, remote units, and the like as discussed and described herein.

The principles and concepts discussed and described may be particularly applicable to communication units, devices, and systems providing or facilitating voice communications services or data or messaging services over wide area networks (WANs), such as conventional two way systems and devices, various cellular phone systems including analog and digital cellular, CDMA (code division multiple access) and variants thereof, GSM (Global System for Mobile communications), GPRS (General Packet Radio System), 2.5 G and 3G systems such as UMTS (Universal Mobile Telecommunication Service) systems, 4G OFDM (Orthogonal Frequency Division Multiplex) systems, integrated digital enhanced networks and variants or evolutions thereof. Principles and concepts described herein may further be applied in devices or systems with short range communications capability normally referred to as W-LAN capabilities, such as IEEE 802.11, 802.15, Bluetooth, HiperLAN, and the like that preferably utilize CDMA, frequency hopping, orthogonal frequency division multiplexing, or TDMA access technologies and one or more of various networking protocols, such as TCP/IP (Transmission Control Protocol/Internet Protocol), IPX/SPX (Inter-Packet Exchange/Sequential Packet Exchange), Net BIOS (Network Basic Input Output System), UDP (User Datagram Protocol) or other protocol structures.

The instant disclosure is provided to further explain in an enabling fashion the best modes of making and using various embodiments in accordance with the present invention. The disclosure is further offered to enhance an understanding and appreciation for the inventive principles and advantages thereof, rather than to limit in any manner the invention. The invention is defined solely by the appended claims including any amendments made during the pendency of this application and all equivalents of those claims as issued.

It is further understood that the use of relational terms, if any, such as first and second, top and bottom, and the like are used solely to distinguish one from another entity or action without necessarily requiring or implying any actual such relationship or order between such entities or actions.

Much of the inventive functionality and many of the inventive principles are best implemented with or in software programs or instructions and integrated circuits (ICs) such as application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. Therefore, in the interest of brevity and minimization of any risk of obscuring the principles and concepts according to the present invention, further discussion of such software and ICs, if any, will be limited to the essentials with respect to the principles and concepts used by the preferred embodiments.

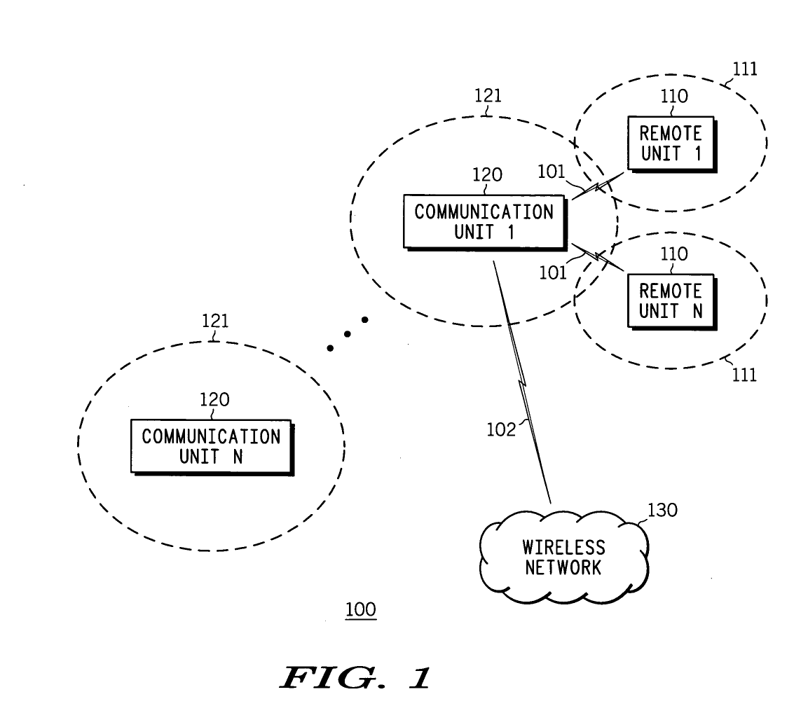

Referring to FIG. 1, a simplified and representative diagram of exemplary environment 100 having one or more remote units 110, one or more communication units 120, and wireless network 130 is shown. Exemplary ad-hoc network connections 101 shown, for example, as being present between remote unit 1 110 and communication unit 1 120, and remote unit N 110 and communication unit 1 120 may be established provided that respective ad-hoc coverage areas 111 of remote unit 1 110 and remote unit N 110, are within the ad-hoc coverage area 121 of communication unit 1 120. It will be appreciated that in accordance with various ad-hoc network standards and protocols, such as Bluetooth, IEEE 802.xx, such as IEEE 802.11, 802.15, etc., or the like, connectivity within an ad-hoc connection environment, such as piconet/mobile mesh networks, may be established based on the proximity of units to each other such that, for example, coverage areas overlap. It will further be appreciated that in accordance with various ad-hoc standards, wireless techniques apart from the radio frequency domain may be used including for example, infrared, or the like. Once overlapping coverage is established by way of proximity, units may connect according to ad-hoc protocols to be described in greater detail hereinafter.

Communication unit 1 120 may further establish connection 102 to wireless network 130 upon a request from one or more remote units 110 which may be issued using a voice command or the like as will also be described in greater detail hereinafter. The voice command may correspond to a network control command such as a connection request and may be transmitted to communication unit 1 120 over ad-hoc network connection 101. In order to complete the connection however, network security and authentication procedures will require an identifier to be associated with the access request. Thus in accordance with various exemplary and alternative exemplary embodiments, an identifier, such as an ESN, MIN, NAI, or the like associated with remote unit 110 may be temporarily assigned to or “adopted” by communication unit 120 over ad-hoc network connection 101.

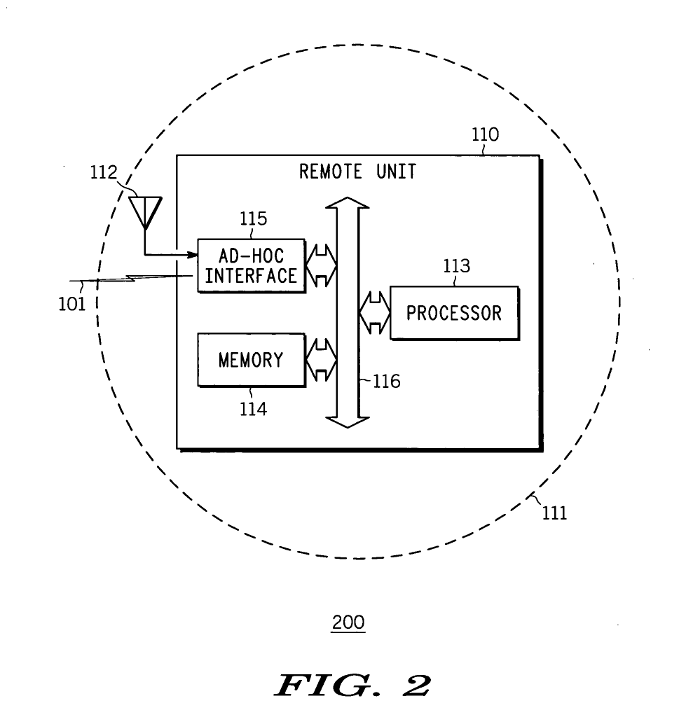

To provide a better understanding of operation in accordance with various exemplary and alternative exemplary embodiments, a more detailed block diagram 200 of exemplary remote unit 110 is shown in FIG. 2. Therein, remote unit 110 is shown to include antenna 112 which may be an integrated antenna, internal or external antenna, or the like, for reception and transmission in accordance with the ad-hoc protocol associated with ad-hoc network connection 101 for receiving and transmitting signals.

Antenna 112 is further preferably coupled to ad-hoc interface 115 including a transceiver, etc. which may be configured for processing raw incoming radio signals, for example, from antenna 112, and providing conditioned signals such as digital signals, or the like to other sections or devices by way of interconnection 116 which may be a signal path, bus, or the like. It will further be appreciated that various functions such as analog-to-digital conversion or other conditioning, decoding, or the like, of the incoming signal or samples representative thereof may be allocated in one or several sections within remote unit 110. Note that a corresponding process, essentially in reverse is utilized to generate and radiate transmit signals from the antenna 112.

Exemplary remote unit 110 shown in FIG. 2, may further include processor 113 having memory 114 associated therewith. It will be appreciated that memory 114 may be an internal memory, an external memory, or the like as would be known by one of ordinary skill and sufficiently matched, for example, to the speed and other performance related characteristics of processor 113, ad-hoc interface 115, interrconnection 116 and other devices within communication unit 110 to enable useful storage of and access to programs, data, instructions, or the like associated with operation in accordance with various embodiments.

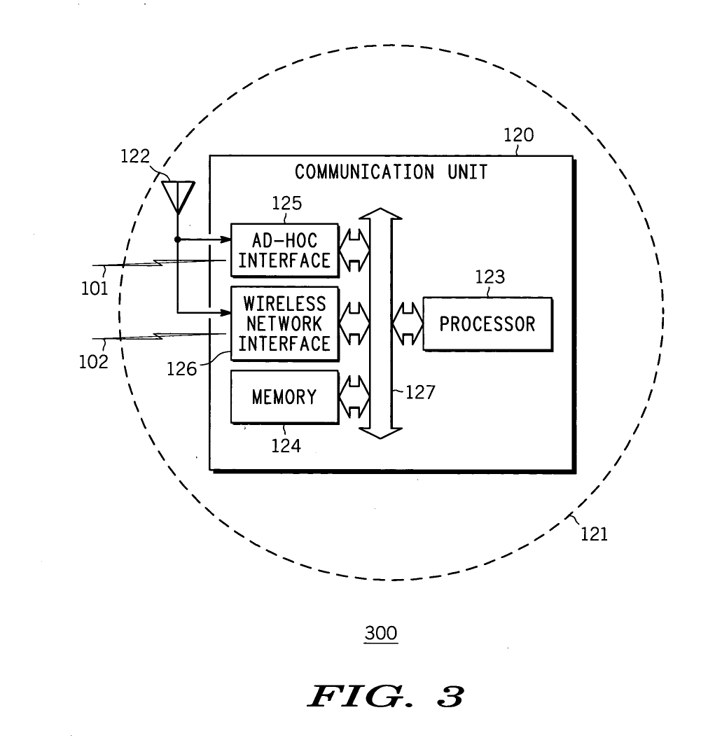

A more detailed block diagram 300 of exemplary communication unit 120 is shown in FIG. 3. It will be appreciated that while communication unit 120 may be any one of many types of wireless communication units capable of providing a connection to, for example, wireless network 130, it preferably acts as a relay unit for providing such network connections to remote units, such as remote unit 110, which come within coverage area 121 thereof. Moreover, while antenna 122 may be associated with both ad-hoc network connection 101 and wireless network connection 102, separate antennae may alternatively be provided for ad-hoc network connection 101 and wireless network connection 102 without departing from the invention. As will be appreciated by one of ordinary skill in the art, antenna 122 may be an integrated antenna, internal or external antenna, or the like, for reception and transmission in accordance with both the ad-hoc protocol associated with ad-hoc network connection 101 and wireless network connection 102, for receiving and transmitting signals associated therewith.

Antenna 122 is further preferably coupled to ad-hoc interface 125 and wireless network interface 126, each including corresponding transceivers and both of which may be configured for processing raw incoming baseband signals, for example, from antenna 122, the signals associated with respective interfaces and preferably compliant with one or more protocols associated with the various interfaces, and providing conditioned signals such as digital signals, or the like to other sections or devices by way of interconnection 127 which may be a signal path, bus, or the like. It will further be appreciated that various functions such as analog-to-digital conversion or other conditioning, decoding, or the like, of the incoming signal or samples representative thereof may be allocated in one or several sections within communication unit 120. Similar processes are undertaken more or less in reverse to provide respective transmit signals for the network connections 101, 102.

Exemplary communication unit 120 as shown in FIG. 3, may further include processor 123 having memory 124 associated therewith which may be an internal memory, an external memory, or the like as would be known by one of ordinary skill and sufficiently matched, for example, to the speed and other performance related characteristics of processor 123, ad-hoc interface 125, wireless network interface 126, bus or interconnection 127, and other devices within communication unit 110 to enable useful storage of and access to programs, data, instructions, or the like associated with operation in accordance with various embodiments.

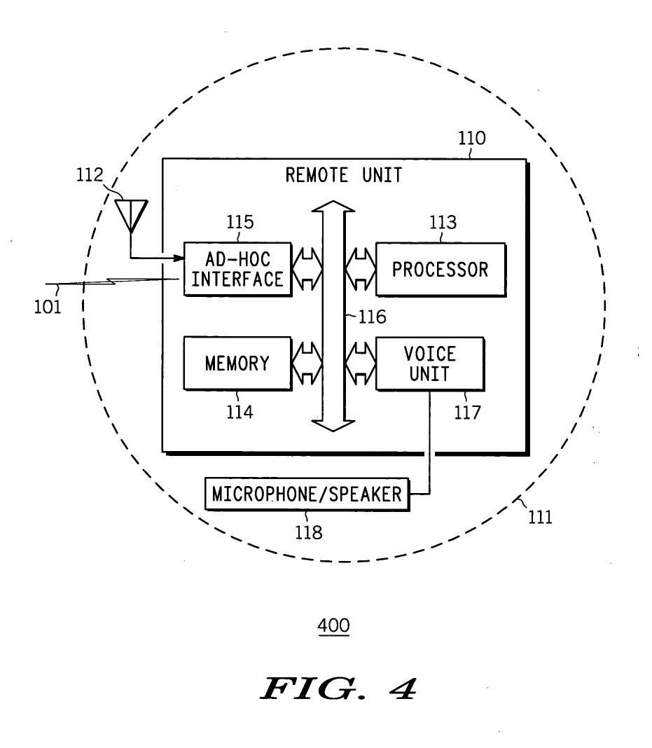

To further facilitate the exemplary connection between remote unit 110 and wireless network 130 through, for example, communication unit 120, a block diagram 400 further illustrates components associated with remote unit 110 as shown in FIG. 4. In accordance with various exemplary and alternative exemplary embodiments, voice unit 117, having voice frequency input/output devices such as microphone/speaker 118, may be provided to allow voice commands from a user to be received and processed and transferred, for example, over ad-hoc network connection 101 to communication unit 120 and to allow normal voice channel signals to be transferred once the connection with wireless network 130 is set up.

As will be appreciated, voice unit 117 preferably includes an analog-to-digital converter (not shown), and various front end processing capabilities for, for example, microphone 118 for conditioning the incoming voice signal and performing noise reduction and the like. The voice unit 117 also converts received signals into voice signals suitable to drive the speaker. Alternatively, voice unit 117 may simply convert signal plus noise from microphone 118 whereupon processor 113 may perform various signal processing on the voice data stream to provide conditioning and noise reduction. Voice signals may be sent over ad-hoc network connection 101 to communication unit 120 whereupon they may be recognized as will be described in greater detail hereinafter. In such a configuration, it will be appreciated that remote unit 110 is preferably embodied as a wireless headset, clip-on microphone/earpiece, or other relatively discreet and unobtrusive device designed to encourage widespread carrying and use of remote unit 110 by users in an indoor environment such as an office or the like.

Alternatively, voice unit 117 may further act as a voice recognition unit and may transfer recognized commands over ad-hoc network connection 101 to communication unit 120 associated with for example establishing the wireless network connection with wireless network 130.

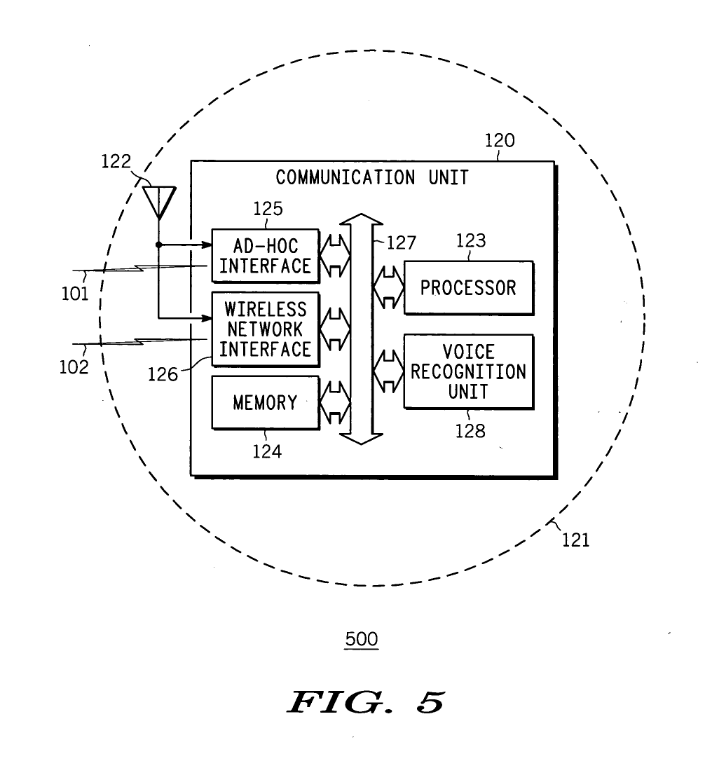

Correspondingly, exemplary components associated with communication unit 120 are shown in FIG. 5. In accordance with various exemplary and alternative exemplary embodiments and exemplary block diagram 500, voice recognition unit 128 may be provided to allow the recognition of voice commands transferred from a user through, for example, voice unit 117 and microphone 118 of remote unit 110, over ad-hoc network connection 101 to be received and processed by communication unit 120. As will be appreciated, voice recognition unit 128 preferably includes a signal processor (not shown), capable of recognizing certain digital sequences associated with phonemes, or other recognizable voice segments as would be appreciated in the art. Alternatively, voice recognition unit 128 may be configured to perform various functions to recognize signals sent over ad-hoc network connection 101 representing voice commands already recognized by, for example, voice unit 117 which may act as a voice recognition unit and may transfer recognized commands over ad-hoc network connection 101 associated with establishing the wireless network connection with wireless network 130.

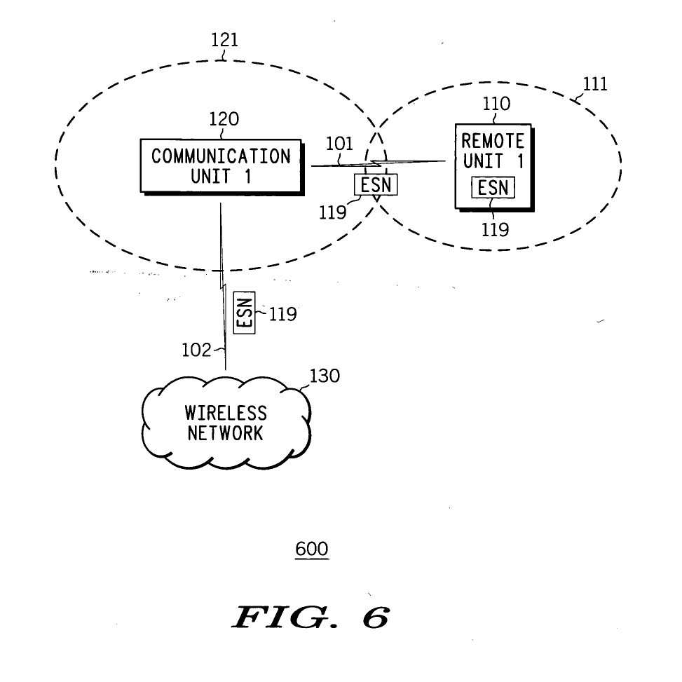

Aside from performing basic commands associated with the establishment of network connection 102, such as a connection request or the like, it will be appreciated that an identifier should be provided or assigned to communication unit 120 as shown in FIG. 6. FIG. 6 is a diagram 600 depicting a connection scenario between a remote unit 110 and a communication unit 120 showing an exemplary adoption of an identifier 119. This identifier can be used for the purposes of establishing an authenticated connection as is required by most wireless network service providers that are capable of providing access to, for example, public wireless networks, public switched telephone networks, or the like. Thus, in accordance with various preferred exemplary embodiments, communication unit 120 is capable of adopting identifier 119 associated with remote unit 110. Identifier 119, as described above, is preferably an identifier, such as an ESN, MIN, NAI, or the like which identifies remote unit 110 and additionally, the subscriber or user thereof, and in a multi-user environment, can direct information associated with wireless network connection 102, to the appropriate remote unit by way of the identifier which may additionally be used to identify the ad-hoc network connection 101 associated with the particular remote unit 110. Note that the identifier is being used not only to identify the remote unit but is also being used to transfer the identity of the remote unit to the communication unit.

Accordingly, any one communication unit 120 may be capable of handling connections for a multiplicity of remote units 110, for example N remote units. In a typical environment, such as an indoor environment, it will further be appreciated that several communication units may be present to provide coverage throughout an indoor environment such that wherever a remote unit 110 is located, a connection may be made to at least one of the N communication units 120. It will still further be appreciated that if a communication unit 120 is not in a location suitable for establishing a wireless network connection with wireless network 130, an additional ad-hoc connection may be established with another communication unit that is able to make a wireless network connection 102.

It should further be evident that in accordance with various techniques known and being developed in the art for ad-hoc connections and networks, handoffs may be accomplished for remote units 110, which move from a coverage area of one communication unit 120 or relay unit to another communication unit 120 or relay unit without departing from the scope of the invention. For example, U.S. patent application Ser. No. 09/795,585 by Dehner et al, filed 2001 02 28 and published as U.S. 20030035464, titled Method and Apparatus for Facilitating Hand off in a Wireless Local Area Network and assigned to the same assignee as here provides useful techniques. Further a publication titled An Inter-Access Point Handoff Mechanism for Wireless Network Management: The Sabino System by Fahd K. Al-Bin-Ali et al. published in June 2003 by the International Conference on Wireless Networks is also useful. These two documents are hereby incorporated herein in there entirety by reference.

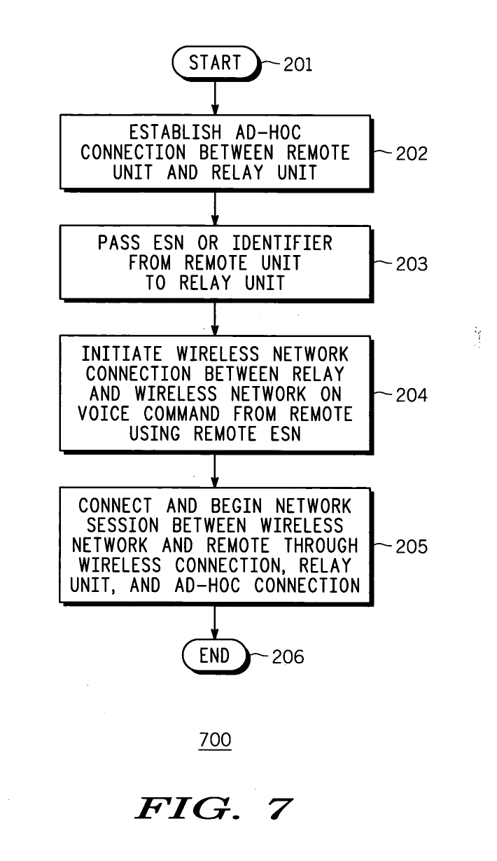

A procedure for the establishment of a network connection in accordance with various exemplary embodiments, can be appreciated by reference to FIG. 7. In exemplary flow chart 700, a process may start at 201 for the establishment of the connection by first establishing an ad-hoc connection at 202, such as ad-hoc network connection 101, based on proximity between remote unit 110 and communication unit 120. It will be appreciated that in accordance with most ad-hoc standards, proximity between ad-hoc capable units precipitates a protocol exchange to allow the establishment of a connection if so desired. Once ad-hoc connection 101 is established, an identifier such as an ESN may be assigned, passed, or otherwise adopted at 203 by communication unit 120, which preferably acts as a relay unit. Once the identifier is adopted, a wireless network connection, such as wireless network connection 102, may be initiated and established at 204, for example, based on a voice command from remote unit 110. Thus a network connection between remote unit 110, and wireless network 130 through communication unit 120 and ad-hoc connection 101 and wireless network connection 102 is provided. A network session may then begin at 205 for the bidirectional transfer of data between remote unit 110 and wireless network 130. The session may proceed until terminated, for example, by another command such as a voice command, signaling a network control function such as an on-hook condition or the like sufficient to terminate the session at 206.

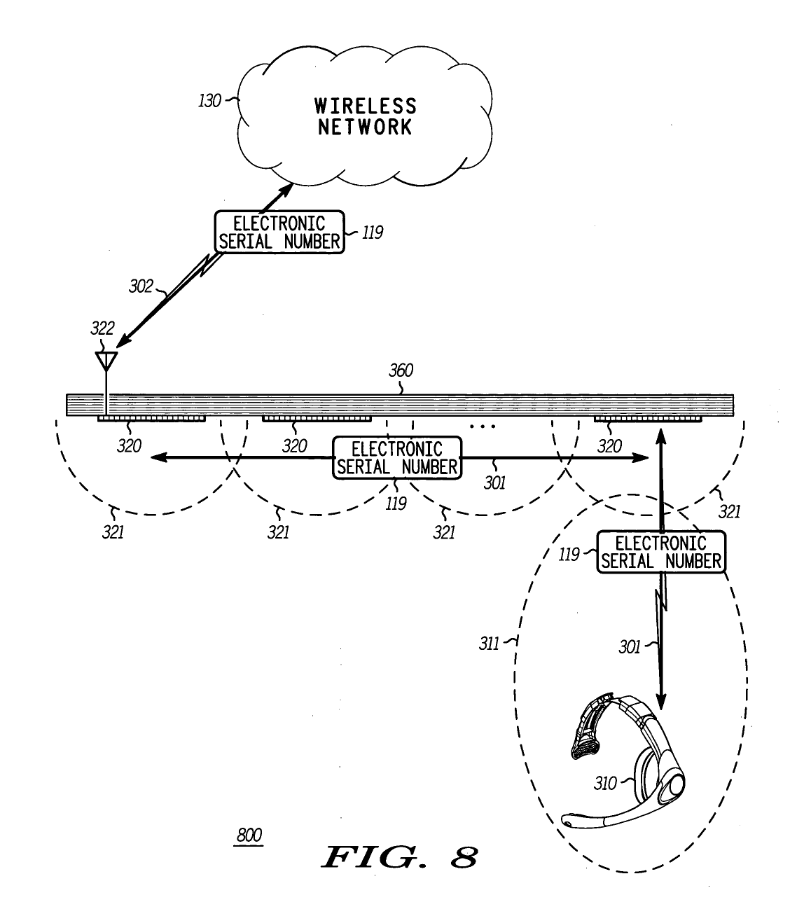

It will further be appreciated that various exemplary embodiments, including procedures and the like as described herein above, may preferably be carried out in exemplary scenario 800 which can be an indoor environment as illustrated in FIG. 8. As shown therein, remote unit 310, which is preferably a wireless headset capable of being discreetly worn by a user, such as an office worker in the exemplary indoor environment, can be connected to wireless network 130, which as noted above is preferably a wireless access network, RAN, or the like for providing wireless or cellular services to a user. In accordance with various procedures as previously described, remote unit 310, through its corresponding ad-hoc coverage area 311, may connect to a proximate communication unit 320, relay unit, or the like, through its corresponding ad-hoc coverage area 321, using, for example, an ad-hoc protocol over ad-hoc network connection 301.

It will be appreciated that ad-hoc network connection 301 may be established or formed automatically or upon demand, for example by discovering and associating with a proximate relay unit, e.g. communication unit, by way of or according to the ad-hoc protocol, when ad-hoc coverage area 311 associated with remote unit 310 comes into overlapping proximity to ad-hoc coverage area 321 associated with communication unit 320. In the exemplary indoor environment, communication unit 320 may preferably be incorporated into a ceiling tile, placed in a ceiling unit 360, or the like to maximize effective coverage. Alternatively, communication unit 320 may be a wireless communication unit placed anywhere inside or outside of the indoor environment, provided that the ability to “adopt” an identifier associated with remote unit 310 is present.

In order to complete the connection between remote unit 310 and wireless network 130, communication unit 320 may establish or have established, additional ad-hoc connections between proximate communication units 320, to complete a combined path there between amounting to an additional leg or legs of ad-hoc network connection 301 to a final communication unit 320, which, since equipped with antenna 322, can connect to the RAN or wireless network 130. It will be appreciated that while only one communication unit 320 is shown as having antenna 322 specifically configured for providing access to wireless network 130, all communication units 320 may be so equipped, or may simply be equipped with an antenna for providing ad-hoc coverage. Alternatively, an exemplary communication unit may be equipped with a combined antenna for providing both ad-hoc network coverage, and wireless network coverage sufficient to provide wireless network access. Note that communication units 320 can be connected to each other using either wireless communication connections or wired communication connections assuming known interfaces are available for such units.

Thus with the ad-hoc connection or network connection established via one or more communication units 320 acting as relay units, the remote unit 310, such as a headset or the like, can be provided access to the wireless network 130 via a wireless connection 302 between a relay unit and that network. Note that this wireless connection 302 can support call origination from the remote unit as well as call reception by the remote unit 310. Call reception would proceed in a normal fashion, with a page to the relay or communication unit 320 that has assumed or adopted the identity, e.g. used the identifier 119 of the remote unit 310. Using the ad-hoc network connection(s) this relay unit can page the remote unit 310 or forward the incoming call signal to the remote unit. The voice unit at the remote unit 310, in some embodiments, would provide an audio cue to the user, such as a ringing signal or an audible rendition of caller ID information. If the user wished to answer the call a spoken command, such as “talk” or “answer,” can be sent to and recognized by the voice unit of the remote or relay unit and the call answered and thus connected.

This disclosure is intended to explain how to fashion and use various embodiments in accordance with the invention rather than to limit the true, intended, and fair scope and spirit thereof. The foregoing description is not intended to be exhaustive or to limit the invention to the precise form disclosed. Modifications or variations are possible in light of the above teachings. The embodiment(s) was chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally, and equitably entitled.

1. A method for providing access to a wireless network using an ad-hoc network connection, the method comprising:
assigning an identifier associated with the ad-hoc network connection; and
establishing a wireless network connection to provide access to the wireless network through the ad-hoc network connection based on the assigned identifier associated with the ad-hoc network connection.

2. A method according to claim 1, wherein the ad-hoc network connection is made according to a protocol including one of: a Bluetooth protocol, and an IEEE 802.xx protocol.

3. A method according to claim 1, wherein the identifier includes one of an Electronic Serial Number (ESN), Network Access Identifier (NAI), Mobile Identification Number (MIN), and Mobile IP (MIP) address.

4. A method according to claim 1, further comprising:
transmitting a voice command over the ad-hoc network connection, the voice command associated with a wireless network control function; and
recognizing the voice command and initiating the wireless network control function associated with the voice command.

5. A method according to claim 1, further comprising:
establishing the ad-hoc network connection between a remote unit and a relay unit, the remote unit uniquely identified by the identifier;
assigning the identifier to the relay unit; and
establishing the wireless network connection between the relay unit and the wireless network to provide access for the remote unit to the wireless network through the relay unit and the ad-hoc network connection based on the identifier assigned to the relay unit.

6. A method according to claim 5, further comprising assigning a plurality of identifiers associated with a plurality of remote units to the relay unit.

7. A method according to claim 5, wherein the relay unit includes a wireless communication unit.

8. A method according to claim 5, wherein the remote unit includes a voice unit and the relay unit includes a voice recognition unit.

9. A method according to claim 5, further comprising:
transmitting a voice command over the ad-hoc network connection to the relay unit, the voice command associated with a wireless network control function; and
recognizing the voice command at the relay unit and initiating the wireless network control function associated with the voice command.

10. A method according to claim 5, wherein the remote unit includes a headset.

11. A method according to claim 5, wherein the establishing the ad-hoc network connection further comprises discovering and associating with a proximate relay unit.

12. A method according to claim 5, wherein the ad-hoc network connection is handed off from the relay unit to an other relay unit.

13. A method according to claim 5, wherein the establishing the wireless network connection to provide access for the remote unit to the wireless network through the relay unit further provides access for one of a call origination and a call reception.

14. An apparatus in a relay unit for facilitating access for a remote unit to a wireless network through an ad-hoc network connection, the apparatus comprising:
an ad-hoc interface operable to support the ad-hoc network connection;
a memory; and
a processor coupled to the memory and the ad-hoc interface, the memory storing instructions for causing the processor to:
establish the ad-hoc network connection with the remote unit; and
adopt an identifier associated with the remote unit.

15. An apparatus according to claim 14, wherein the ad-hoc network connection is made according to a protocol including one of: a Bluetooth protocol and an IEEE 802.xx protocol.

16. An apparatus according to claim 14, wherein the identifier includes one of an Electronic Serial Number (ESN), Network Access Identifier (NAI), Mobile Identification Number (MIN), and Mobile IP (MIP) address.

17. An apparatus according to claim 14 further comprising a wireless network interface operable to support a wireless network connection, wherein the processor is coupled to the wireless network interface and the memory is further storing instructions for causing the processor to establish the wireless network connection to provide access for the remote unit to the wireless network through the ad-hoc network connection based on the identifier and a command received from the remote unit through the ad-hoc network connection.

18. An apparatus according to claim 17, wherein the instructions further cause the processor to:
receive a voice command over the ad-hoc network connection, the voice command associated with a wireless network control function; and
recognize the voice command and initiate the wireless network control function associated with the voice command.

19. An apparatus according to claim 14, wherein the relay unit includes a voice recognition unit.

20. An apparatus according to claim 14, wherein the remote unit includes a headset.

21. An apparatus in a remote unit for providing access to a wireless network through an ad-hoc network connection, the apparatus comprising:
an ad-hoc interface operable to support the ad-hoc network connection;
a memory; and
a processor coupled to the memory, the ad-hoc interface, the memory storing instructions for causing the processor to:
establish the ad-hoc network connection with a relay unit;
assign an identifier associated with the remote unit to the relay unit; and
initiate the establishing of a wireless network connection between the relay unit and the wireless network to provide access to the wireless network through the relay unit and the ad-hoc network connection based on the identifier.

22. An apparatus according to claim 21, wherein the ad-hoc network connection is made according to a protocol including one of: a Bluetooth protocol and an IEEE 802.xx protocol.

23. An apparatus according to claim 21, wherein the identifier includes one of an Electronic Serial Number (ESN), Network Access Identifier (NAI), Mobile Identification Number (MIN), and Mobile IP (MIP) address.

24. An apparatus according to claim 21, wherein the remote unit includes a voice unit for receiving a voice command.

25. An apparatus according to claim 24, wherein the instructions further cause the processor to:
transmit the voice command over the ad-hoc network connection to the relay unit, the voice command associated with a wireless network control function; wherein the voice command is capable of being recognized at the relay unit and the wireless network control function associated with the voice command is capable of being initiated.

26. An apparatus according to claim 21, wherein the remote unit includes a headset.
